(19) United States
(12) Patent Application Publication
(10) Pub. No.: US 2026/0120256 A1
(43) Pub. Date: Apr. 30, 2026

(54) DEEP-LEARNING-BASED METHODS FOR ELIMINATING BROADBAND EFFECTS AND SYNTHESIZED-BEAM EFFECTS IN LOW-FREQUENCY SKA

(71) Applicant: GUIZHOU UNIVERSITY, Guiyang (CN)

(72) Inventors: Li ZHANG, Guiyang (CN); Zhibin ZHANG, Guiyang (CN); Daihu YANG, Guiyang (CN); Mei LU, Guiyang (CN); Yousuo DONG, Guiyang (CN)

(73) Assignee: GUIZHOU UNIVERSITY, Guiyang (CN)

(21) Appl. No.: 19/433,043

(22) Filed: Dec. 25, 2025

(30) Foreign Application Priority Data
Sep. 29, 2024 (CN) 202411370248.7

(51) Int. Cl. G06T 5/80; G06N 3/045; G06N 3/0464; G06T 5/60; G06V 10/77

(52) U.S. Cl. CPC G06T 5/80; G06N 3/045; G06N 3/0464; G06T 5/60; G06V 10/7715; G06T 2207/20084

(57) ABSTRACT

A deep-learning-based method for eliminating a broadband effect and a synthesized-beam effect in low-frequency Square Kilometre Array (SKA) is provided. The method includes: establishing a frequency-domain extraction module, a feature enhancement module, and a frequency-domain gating module; constructing, based on the frequency-domain extraction module, the feature enhancement module, and the frequency-domain gating module, a neural network model based on a frequency-domain self-attention mechanism; performing primary feature extraction on an input image based on the feature enhancement module to obtain a low-level feature; inputting the low-level feature into the frequency-domain gating module and performing downsampling to achieve feature encoding, so as to obtain an encoded feature; inputting the encoded feature into the frequency-domain extraction module and performing frequency-domain attention computation and upsampling to achieve feature decoding, so as to obtain a decoded feature; and inputting the decoded feature into the feature enhancement module to obtain a target restored image.

### TECHNICAL FIELD

The present disclosure relates to a technical field of radio astronomy image processing, and in particular to a deep-learning-based method for eliminating a broadband effect and a synthesized-beam effect in low-frequency Square Kilometre Array (SKA).

### BACKGROUND

In radio astronomy, the Square Kilometre Array (SKA) provides unprecedented technical means for cosmic observation due to its ultra-high sensitivity, resolution, and rapid measurement capability. However, when using the SKA for low-frequency wideband observation and imaging, a broadband effect and a synthesized-beam effect lead to severe degradation of imaging quality, manifested as distortion and blurring of a celestial structure after imaging.

The broadband effect arises from the finite observational bandwidth, which causes radial smearing of the visibility function in the uv-plane, and the extent of such radial smearing is positively correlated with the bandwidth. The synthesized-beam effect results from incomplete sampling of the Fourier plane, which leads to sidelobes of the telescope's point-spread function and consequently produces image blurring during sky-brightness reconstruction. The broadband effect and the synthesized-beam effect are mutually coupled, further exacerbating the degradation of the observational data. The degree of impact depends on multiple factors, including observational frequency, observation duration, bandwidth, and field of view.

Currently, mitigation of the broadband effect and the synthesized-beam effect in low-frequency SKA is primarily achieved through a staged processing approach: first, the broadband effect is suppressed using Multi-Frequency Synthesis (MFS), and then the synthesized-beam effect is removed using the CLEAN algorithm. However, this approach relies on manual modeling and repeated parameter adjustments, resulting in low efficiency and making it difficult to fully eliminate the coupled influence of the broadband effect and the synthesized-beam effect, thereby limiting the accuracy of sky-brightness recovery.

Therefore, a deep-learning-based method for eliminating a broadband effect and a synthesized-beam effect in low-frequency SKA is provided to improve the imaging quality of SKA observational data.

### SUMMARY

One or more embodiments of the present disclosure provide a deep-learning-based method for eliminating a low-frequency SKA broadband effect and a synthesized-beam effect. The deep-learning-based method comprises: establishing a frequency-domain extraction module, a feature enhancement module, and a frequency-domain gating module; constructing, based on the frequency-domain extraction module, the feature enhancement module, and the frequency-domain gating module, a neural network model based on a frequency-domain self-attention mechanism; performing primary feature extraction on an input image based on the feature enhancement module to obtain a low-level feature; inputting the low-level feature into the frequency-domain gating module and performing downsampling to achieve feature encoding, so as to obtain an encoded feature; inputting the encoded feature into the frequency-domain extraction module and performing frequency-domain attention computation and upsampling to achieve feature decoding, so as to obtain a decoded feature; and inputting the decoded feature into the feature enhancement module to obtain a target restored image.

The beneficial effects of the present disclosure are as follows:

A deep-learning-based method for eliminating the broadband effect and the synthesized-beam effect in low-frequency SKA is provided in the present disclosure. The method adopts an image-to-image, end-to-end approach. Through large-scale model training, the model is able to sufficiently learn the corresponding feature relationships between clean images of celestial structures and dirty images that contain the broadband effect and the synthesized-beam effect, thereby enabling more efficient and more thorough elimination of the coupled effects.

An improved Transformer model based on a frequency-domain self-attention mechanism is provided in the present disclosure and is successfully applied to the mitigation of the broadband effect and the synthesized-beam effect in low-frequency SKA, offering a new perspective and an effective solution for radio-astronomical image restoration and reconstruction. In the improved Transformer model, the present disclosure employs a Feature Residual Module (FERM) to effectively extract features from radio-astronomical images and to ensure that spatial information is preserved. Finally, the present disclosure designs a new frequency-domain-gated network (FGFN), which preserves useful high-frequency and low-frequency information while controlling the forward transmission of complementary information.

The deep-learning-based method provided by the present disclosure can more effectively jointly eliminate the broadband effect and the synthesized-beam effect and restore and reconstruct the original sky brightness to a greater extent. The method is time-efficient; through large-scale model training, the model sufficiently learns the relevant features, thereby significantly reducing the time required for effect elimination. The method is also easy to operate. Traditional mitigation approaches require manual model design and are highly dependent on parameter tuning, whereas the method provided herein employs deep-learning techniques that greatly simplify manual operations involved in effect elimination.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is an exemplary flowchart illustrating a deep-learning-based method for eliminating a broadband effect and a synthesized-beam effect in low-frequency SKA according to some embodiments of the present disclosure;

FIG. 2 is a schematic diagram illustrating an exemplary implementation architecture of a frequency-domain extraction module according to some embodiments of the present disclosure;

FIG. 3 is a schematic diagram illustrating an exemplary implementation architecture of a frequency-domain gating module according to some embodiments of the present disclosure;

FIG. 4 is a schematic diagram illustrating an exemplary implementation architecture of a feature enhancement module according to some embodiments of the present disclosure; and

FIG. 5 is an exemplary design diagram illustrating an Iterative Frequency-domain Self-attention Transformer (IFS-Transformer) network model according to some embodiments of the present disclosure.

### DETAILED DESCRIPTION

To more clearly illustrate the technical solutions in the embodiments of the present disclosure, the drawings used in the description of the embodiments will be briefly introduced below. Obviously, drawings described below are only some examples or embodiments of the present disclosure. Those skilled in the art, without further creative efforts, may apply the present disclosure to other similar scenarios according to these drawings. Unless obviously obtained from the context or the context illustrates otherwise, the same numeral in the drawings refers to the same structure or operation.

It should be understood that the “system”, “device”, “unit”, and/or “module” used herein are one method to distinguish different components, elements, parts, sections, or assemblies of different levels. However, the terms may be displaced by other expressions if they may achieve the same purpose.

As shown in the present disclosure and the claims, the singular forms “a”, “an”, “one”, and/or “the” may be intended to include the plural forms as well, unless the context clearly indicates otherwise. Generally, the terms “include” and “comprise” only indicate that the clearly identified steps and elements are included, and these steps and elements do not constitute an exclusive list. The method or device may also include other steps or elements.

The flowcharts used in the present disclosure illustrate operations that systems implement according to some embodiments of the present disclosure. It should be understood that the operations of the flowcharts may be implemented not in order. Conversely, the operations may be implemented in an inverted order, or simultaneously. Meanwhile, other operations may be added to these processes. One or more operations may be removed from these processes.

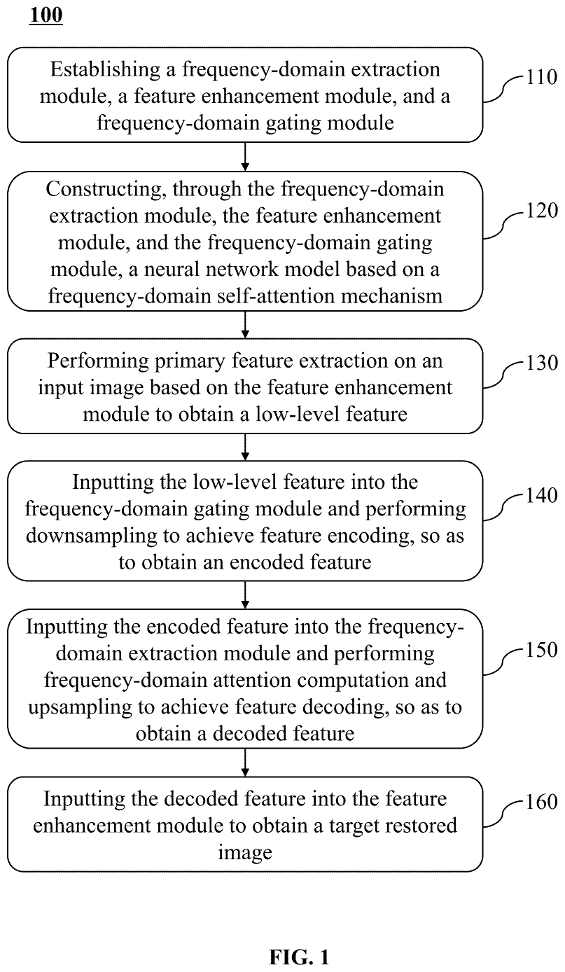

FIG. 1 is an exemplary flowchart illustrating an exemplary process of a deep-learning-based method for eliminating a broadband effect and a synthesized-beam effect in low-frequency SKA according to some embodiments of the present disclosure. As shown in FIG. 1, a process 100 includes operation 110 to operation 160.

In some embodiments, the process 100 may be executed by a processor.

In 110, establishing a frequency-domain extraction module, a feature enhancement module, and a frequency-domain gating module.

The frequency-domain extraction module is configured to implement a frequency-domain self-attention mechanism. The frequency-domain extraction module may compute a correlation (attention weights) between different regions in a feature map.

In some embodiments, the frequency-domain extraction module includes one or more Frequency-domain Self-Attention Solvers (FSASs).

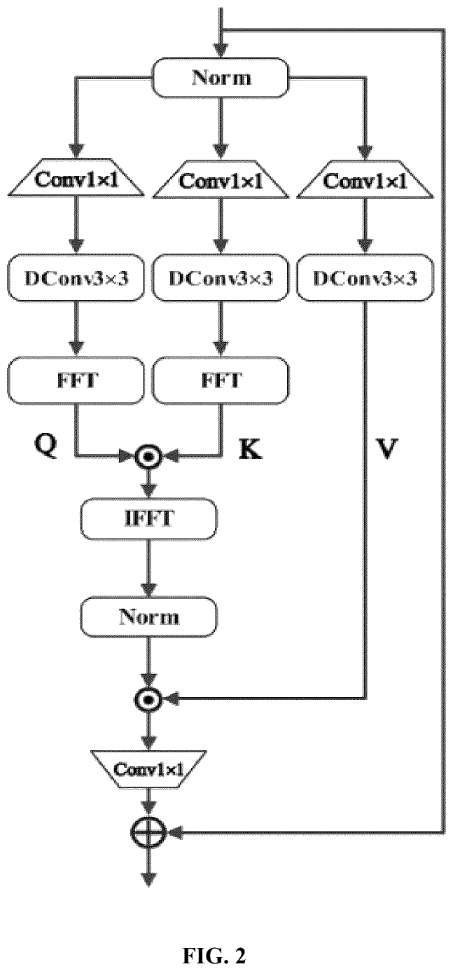

More descriptions regarding constructing the frequency-domain extraction module may be found in FIG. 2 and relevant descriptions thereof.

The feature enhancement module is configured to stably extract multi-level features from an image. In some embodiments, the feature enhancement module may be used for tasks requiring multi-level feature fusion (e.g., super-resolution).

In some embodiments, the feature enhancement module includes one or more Feature Extraction Residual Modules (FERMs). The FERM consists of a convolutional layer and four residual blocks.

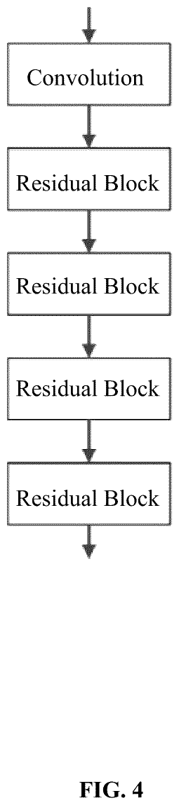

More descriptions regarding constructing the feature enhancement module may be found in FIG. 4 and relevant descriptions thereof.

The frequency-domain gating module is a key module for performing feature transformation and downsampling/upsampling. The frequency-domain gating module integrates a gating mechanism and a frequency-domain processing capability. The gating mechanism (e.g., a product of a Gaussian Error Linear Unit (GELU) activation function and a linear transformation) adaptively controls an information flow and screen useful features. The frequency-domain processing facilitates further processing of transformed features (e.g., through a Fast Fourier Transform (FFT) and an inverse Fast Fourier Transform (IFFT)) to achieve optimization.

In some embodiments, the frequency-domain gating module includes one or more Frequency-domain Gated Feedforward Networks (FGFNs).

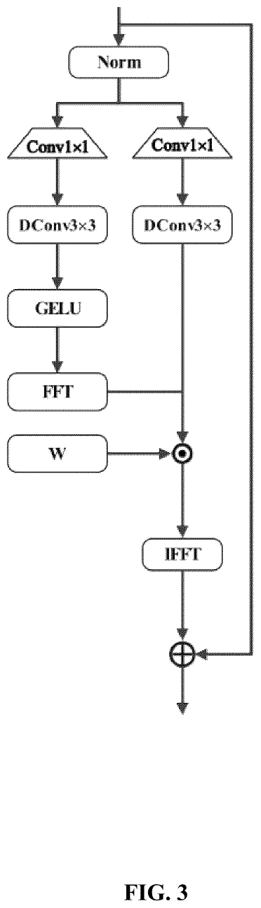

More description regarding constructing the frequency-domain gating module may be found in FIG. 3 and relevant descriptions thereof.

In 120, constructing, through the frequency-domain extraction module, the feature enhancement module, and the frequency-domain gating module, a neural network model based on the frequency-domain self-attention mechanism.

The neural network model based on the frequency-domain self-attention mechanism refers to a deep learning architecture composed of a plurality of modules, configured to learn a mapping relationship from an input to an output in an end-to-end manner. The neural network model based on the frequency-domain self-attention mechanism is capable of integrating a self-attention mechanism with frequency-domain signal processing. By leveraging frequency-domain analysis to effectively capture global and periodic distortions of an image, the model enhances its ability to mitigate the broadband effect and the synthesized-beam effect in radio-astronomical images.

In some embodiments, the neural network model based on the frequency-domain self-attention mechanism includes an Iterative Frequency-domain Self-attention Transformer (IFS-Transformer) network model.

In some embodiments, an architecture of the neural network model includes an encoder and a decoder. The encoder is configured for feature extraction and compression. The decoder is configured for feature reconstruction and restoration.

In some embodiments, the encoder at least includes the feature enhancement module and the frequency-domain gating module. The encoder is configured to perform feature extraction and downsampling encoding on an input image to obtain an encoded feature. The decoder at least includes the frequency-domain extraction module and the frequency-domain gating module. The decoder is configured to perform feature learning and upsampling decoding on the encoded feature to obtain a decoded feature. More description regarding the decoded feature and the encoded feature may be found in step 140 and step 150 and related descriptions thereof.

Step 130, performing primary feature extraction on an input image based on the feature enhancement module to obtain a low-level feature.

The input image refers to a processing object of the neural network model. The input image may be a sky brightness distribution image obtained from low-frequency SKA telescope observations after preliminary imaging processing and containing the broadband effect and the synthesized-beam effect. In the field of radio astronomy, such an image is commonly referred to as a “dirty image.”

In some embodiments, the input image is represented in the form of a two-dimensional or three-dimensional matrix, with a mathematical expression I∈R^{H×W×C}, where H represents a height of the image, i.e., the count of pixel rows; W represents a width of the image, i.e., the count of pixel columns; C represents the count of channels of the image, corresponding to the count of observed frequency points. In broadband observation, C>1, indicating that the data constitutes a set of multi-frequency point data cubes.

The primary feature extraction refers to an operation of performing preliminary processing on the original input image through the feature enhancement module of the model, to extract the basic low-level feature including a large amount of spatial details.

The low-level feature refers to a primary feature representation obtained after the input image undergoes primary feature processing by the feature enhancement module.

In some embodiments, the low-level feature may include local structural information of the input image, e.g., a texture, a geometric shape, or the like of the image.

In some embodiments, dimensions of the low-level feature are the same as dimensions of the input image, which may be expressed as F₀∈R^{H×W×C}.

In some embodiments, the processor may process the input image based on the convolutional layer of the FERM. The convolutional layer extracts the most basic features, e.g., an edge, a corner, a texture, or the like, by sliding a convolution kernel over the input image. Subsequently, the basic features pass through the four residual blocks. Each residual block includes a plurality of convolutional layers and a shortcut connection. The shortcut connection directly adds an input of the residual block to an output thereof to obtain the low-level feature.

For example, the processor may obtain the low-level feature F₀∈R^{H×W×C} of the input image I∈R^{H×W×C} using two FERMs.

In 140, inputting the low-level feature into the frequency-domain gating module and performing downsampling to achieve feature encoding, so as to obtain an encoded feature.

The downsampling refers to an operation that reduces an amount of computation by lowering a data resolution or dimensionality while retaining key information. In some embodiments, the downsampling may be implemented through pooling or strided convolution.

The feature encoding refers to an operation of converting original data (e.g., the input image) into a high-dimensional feature representation. In some embodiments, the feature encoding may be performed to extract discriminative patterns.

The encoded feature refers to a compact representation obtained through the feature encoding. In some embodiments, the encoded feature may be a low-dimensional, high-semantic tensor.

In some embodiments, the processor may convert the low-level feature into the encoded feature after processing by the frequency-domain gating module (e.g., an FGFN) and the downsampling. For example, the processor may input the low-level feature F₀∈R^{H×W×C} into the FGFN, and complete the feature encoding through two downsampling operations to obtain the encoded feature.

In 150, inputting the encoded feature into the frequency-domain extraction module and performing frequency-domain attention computation and upsampling to achieve feature decoding, so as to obtain a decoded feature.

The frequency-domain attention computation refers to transforming a feature map into a frequency domain through an FFT, analyzing the importance of different frequency components, generating attention weights to enhance key frequency components, and suppressing noise or irrelevant frequencies.

The process of the frequency-domain attention computation may include S1: frequency-domain transformation, S2: frequency-domain correlation computation, and S3: attention weight generation. Specifically:
S1, frequency-domain transformation: the FSAS maps the encoded feature (or a transformed query Q or key K thereof) from a spatial domain to the frequency domain through the FFT.
S2, frequency-domain correlation computation: in the frequency domain, global correlations between different feature positions are computed. For example, through operations such as conjugate multiplication, portions of the feature map that are highly correlated in the frequency domain are estimated. This is crucial for identifying and reconstructing celestial structures with periodic or global correlations that have been corrupted by the broadband effect and the synthesized-beam effect.
S3, attention weight generation: the computed frequency-domain correlations are transformed (through an inverse FFT) and normalized to form a set of attention weights. The weights indicate which information from all other positions in the encoded feature should be “attended to” when reconstructing a current pixel point.

After the frequency-domain attention computation is performed on the encoded feature, the feature map may be obtained.

The upsampling refers to an operation that increases a spatial resolution of the feature map through interpolation or transposed convolution to restore detailed information. The upsampling may increase spatial dimensions (e.g., height and width) of the feature map, gradually restore detailed information lost during the encoding process, and ultimately reconstruct a high-resolution image.

In deep learning, the upsampling is implemented by transposed convolution or interpolation manners (e.g., bilinear interpolation and nearest neighbor interpolation). The operations may be understood as an inverse process of downsampling, which may enlarge a low-resolution feature map to a high resolution.

The decoded feature refers to an output feature after the feature decoding. In some embodiments, the decoded feature may be a high-resolution, task-related representation, e.g., a segmentation mask, a generated image, or the like.

In some embodiments, the processor may input the encoded feature into three FSASs for processing, followed by two upsampling operations to implement the feature decoding and obtain the decoded feature.

Step 160, inputting the decoded feature into the feature enhancement module to obtain a target restored image.

The target restored image refers to a high-quality image reconstructed from the input image that meets expected objectives. In some embodiments, the target restored image may include a high-resolution restored image, a denoised clean image, or the like.

In some embodiments, the processor may process the decoded feature using two FERMs to obtain the target restored image.

Some embodiments of the present disclosure have the following beneficial effects:

From a computer vision perspective, the elimination of low-frequency SKA observation effects may be viewed as an image deblurring problem. Leveraging the successful application of Transformer architectures in computer vision, the efficient IFS-Transformer network model provided in the present disclosure jointly mitigates both the broadband effect and synthesized-beam effect in low-frequency SKA. The IFS-Transformer network model utilizes an effective Feature Extraction Residual Module (FERM) augmented with residual connections, which effectively alleviates the truncation of long-range dependent features caused by partitioning the input image into patches, thereby ensuring both the accuracy and efficiency of image restoration. To achieve a network architecture better suited for radio astronomical image deblurring, improvements have been made to the feedforward network. Some embodiments of the present disclosure provide a novel Frequency-domain Gated Feedforward Network (FGFN), capable of transmitting features with complementary characteristics while preserving useful frequency components.

Standard visual Transformer models, inspired by the success of Transformers in natural language processing, partition the input image into patches and linearly flatten these patches into sequences as input to the Transformer. This processing of the input image implies that some features exhibiting long-range dependencies are disrupted. Consequently, the standard visual Transformer model primarily attends to features with short-range dependencies within each patch, potentially leading to the loss of spatial pixel correlations present in the input image.

Therefore, the Feature Extraction Residual Module (FERM) is employed within the standard visual Transformer framework. The FERM includes a convolutional layer and four residual blocks, enabling it to effectively capture features with long-range dependencies in the input image without causing loss of spatial information.

FIG. 2 is a schematic diagram illustrating an exemplary implementation architecture of a frequency-domain extraction module according to some embodiments of the present disclosure.

In some embodiments, one manner for a processor to construct the frequency-domain extraction module includes: determining, based on input feature data, a query vector, a key vector, and a value vector through image patch extraction and linear transformation; determining, based on the query vector and the key vector, an aggregated feature through attention weight calculation and weighted aggregation; and determining, based on the input feature data and the aggregated feature, an output feature of the frequency-domain extraction module through a residual connection.

The input feature data refers to an original feature map entering the frequency-domain extraction module. In some embodiments, the input feature data includes local and global information of an image.

The image patch extraction refers to dividing the input feature data into local regions (referred to as patches) for capturing local features (e.g., an edge and a texture) or reducing computational complexity.

The linear transformation refers to performing linear mapping on the input feature data through matrix multiplication.

The query vector is used to compute attention weights. The key vector is used to compute a similarity with the query vector and determine an allocation of attention weights. The value vector stores actual feature information and is used to perform weighted aggregation after computing the attention weights.

In some embodiments, the processor performs the image patch extraction on the input feature data, divides the input feature data into local patches and flattens the local patches into vectors, and then performs the linear transformation on the flattened vector of each local patch respectively. The processor maps the flattened vector of a same local patch to a query space, a key space, and a value space using different weight matrices, thereby obtaining the query vector, the key vector, and the value vector.

The aggregated feature refers to a feature weighted by the attention weights.

In some embodiments, the processor computes a similarity between the query vector and the key vector to obtain the attention weights, and then performs weighted summation on the value vector to determine the aggregated feature.

The output feature refers to a final feature output by the frequency-domain extraction module.

In some embodiments of the present disclosure, the frequency-domain extraction module maps the input feature to the frequency domain, uses interaction of the query vector, the key vector, and the value vector to compute the attention weights, and implements adaptive enhancement or suppression of different frequency components. The frequency-domain extraction module combines the residual connection to retain original feature information, thereby significantly improving restoration quality of high-frequency details in an image restoration task. Meanwhile, the frequency-domain extraction module avoids problems of high computational complexity and local window limitations of a conventional spatial-domain attention mechanism, and achieves a higher signal-to-noise ratio and more natural visual restoration effect in tasks such as denoising and deblurring.

In some embodiments, the input feature data includes a feature F_{q}, a feature Fₖ, and a feature Fᵥ.

In some embodiments, the processor may obtain an image patch

$${\{ {q}_{i} \}}_{i = 1}^{n} ,$$

an image patch

$${\{ {k}_{i} \}}_{i = 1}^{n} ,$$

and an image patch

$${\{ {v}_{i} \}}_{i = 1}^{n} ,$$

through the image patch extraction based on the feature F_{q}, the feature Fₖ, and the feature Fᵥ; and obtain a query vector Q, a key vector K, and a value vector V through the linear transformation based on the image patch

$${\{ {q}_{i} \}}_{i = 1}^{n} ,$$

the image patch

$${\{ {k}_{i} \}}_{i = 1}^{n} ,$$

and the image patch

$${\{ {v}_{i} \}}_{i = 1}^{n} .$$

For example, the frequency-domain extraction module determines the query vector Q, the key vector K, and the value vector V through Equation (1):

$$Q = R ( {\{ {q}_{i} \}}_{i = 1}^{n} ) , K = R ( {\{ {k}_{i} \}}_{i = 1}^{n} ) , V = R ( {\{ {v}_{i} \}}_{i = 1}^{n} ) , \qquad ( 1 )$$

wherein R represents a reshape function, i represents an i-th image patch, n represents the count of image patches, qᵢ represents a vectorized form of the i-th image patch from the feature F_{q}, kᵢ represents a vectorized form of the i-th image patch from the feature Fₖ, and vᵢ represents a vectorized form of the i-th image patch from the feature Fᵥ.

In some embodiments, the processor may determine a similarity between the query vector Q and the key vector K based on the query vector Q and the key vector K; determine an attention distribution by performing normalization processing based on the similarity between the query vector Q and the key vector K; and determine the aggregated feature through weighted aggregation based on the attention distribution and the value vector V.

The similarity refers to a measure of a degree of association between the query vector Q and the key vector K In some embodiments, the similarity is determined through a dot product, a cosine similarity, or the like.

The normalization processing includes Softmax normalization, Sigmoid normalization, layer normalization, or the like.

In some embodiments, the processor determines the similarity between the query vector Q and the key vector K based on the query vector Q and the key vector K. For example, the processor determines the similarity QK^{T} between the query vector Q and the key vector K through Equation (2):

$${( {QK}^{T} )}_{ij} = 〈 {q}_{i} , {k}_{j} 〉 , \qquad ( 2 )$$

where qᵢ represents a vectorized form of the i-th image patch from the feature F_{q}, kⱼ represents a vectorized form of the j-th image patch from the feature Fₖ, and each element of QK^{T} is obtained via an inner product.

The attention distribution refers to a probability distribution obtained after normalization processing of the similarity. The attention distribution represents a degree of attention each query vector pays to the key vector.

In some embodiments, the processor may obtain the attention distribution by normalizing the similarity between the query vector Q and the key vector K using a Softmax function. For example, the processor determines the attention distribution through Equation (3):

$$soft max ( \frac{{QK}^{T}}{\sqrt{{CH}_{p} {W}_{p}}} ) , \qquad ( 3 )$$

wherein C represents the count of channels, Hₚ represents a height of an extracted image patch, and Wₚ represents a width of the extracted image patch.

In some embodiments, the processor determines the aggregated feature based on the attention distribution and the value vector V through weighted aggregation. For example, the processor determines the aggregated feature through Equation (4):

$${V}_{att} = soft max ( \frac{{QK}^{T}}{\sqrt{{CH}_{p} {W}_{p}}} ) V , \qquad ( 4 )$$

where Vₐₜₜ represents the aggregated feature.

In some embodiments, another manner for the processor to construct the frequency-domain extraction module includes: determining, based on input feature data, a frequency-domain correlation matrix through a frequency-domain transform technique; determining, based on the frequency-domain correlation matrix, an aggregated feature through a layer normalization technique; and determining, based on the input feature data and the aggregated feature, an output feature of the frequency-domain extraction module through a residual connection.

The frequency-domain correlation matrix refers to a matrix representing the correlation of the input feature data in the frequency domain, calculated through frequency-domain transformation (e.g., Fast Fourier Transform), and is used to measure the degree of association between different frequency components.

In some embodiments, the processor may estimate the frequency-domain correlation matrix (denoted as A) between the F_{q} and the Fₖ in a frequency domain by performing a Fast Fourier Transform on the feature F_{q}, the feature Fₖ, and the feature Fᵥ. For example, the processor determines the frequency-domain correlation matrix A between the F_{q} and the Fₖ in the frequency domain through Equation (5):

$$A = {ℱ}^{- 1} ( ℱ ( {F}_{q} ) \overline{ℱ ( {F}_{k} )} ) , \qquad ( 5 )$$

where [symbol] and [symbol] represent the Fast Fourier Transform and the inverse Fast Fourier Transform thereof, respectively, and - represents a conjugate transpose operation.

In some embodiments, the processor may determine the aggregated feature (denoted as Vₐₜₜ) by normalizing the frequency-domain correlation matrix using a layer norm [symbol] (⋅). For example, the processor determines the aggregated feature Vₐₜₜ through Equation (6):

$${V}_{att} = ℒ ( A ) {F}_{v} . \qquad ( 6 )$$

In some embodiments, the processor determines the output feature (denoted as Iₐₜₜ) of the frequency-domain extraction module based on the input feature data and the aggregated feature through the residual connection. For example, the processor obtains the output feature Iₐₜₜ through Equation (7):

$${I}_{att} = I + {Conv}_{1 \times 1} ( {V}_{att} ) , \qquad ( 7 )$$

where I represents the input feature data, and Conv_{1×1} represents a 1×1 convolution.

In some embodiments, as shown in FIG. 2, the detailed network architecture of the frequency-domain extraction module comprises the following processing flow: input data is first subjected to layer normalization (Norm), and the output subsequently branches into three separate data paths. An output from each of the three paths is processed sequentially by a pointwise convolution (Conv1×1) followed by a depthwise convolution (Dconv3×3). The outputs from the first two data paths undergo a Fast Fourier Transform (FFT) to obtain the query vector Q and the key vector K, respectively. The vectors Q and K are then multiplied element-wise, and the product is processed by an Inverse Fast Fourier Transform (IFFT), followed again by layer normalization (Norm). The output from the third data path serves as the value vector V. The value vector V is multiplied element-wise with the result from the aforementioned processing chain (i.e., the normalized IFFT output). The resultant product then passes through a pointwise convolution (Conv1×1). Finally, an output of the pointwise convolution is added element-wise to the original input data, producing a final output and completing the entire architectural processing flow.

FIG. 3 is a schematic diagram illustrating an exemplary implementation architecture of a frequency-domain gating module according to some embodiments of the present disclosure.

In some embodiments, construction of the frequency-domain gating module by the processor including: based on an input tensor, determining an output tensor through a gated linear transformation, frequency-domain bidirectional processing, and a residual connection.

The input tensor refers to an in-place feature representation of the input image. In some embodiments, the input tensor may be a multi-dimensional array, e.g., a 4D tensor with a shape of (Batch, Channels, Height, Width).

The output tensor refers to a feature representation after processing by the frequency-domain gating module. In some embodiments, the output tensor retains a dimensional structure of the input tensor, but the count of channels may be adjusted or the frequency-domain information may be enhanced. For example, if the input tensor is (1, 3, 256, 256), the output tensor may be (1, 64, 256, 256) (with an expanded count of channels) or (1, 3, 256, 256) (retaining the shape of the input tensor but with enhanced frequency-domain information).

In some embodiments, the construction of the frequency-domain gating module further includes:

Based on the input tensor, denoted as I∈R^{Ĥ×Ŵ×Ĉ}, the processor may represent the frequency-domain gating module through Equation (8):

$$\begin{matrix}{I}_{1} = {Conv}_{1 \times 1} ( ℒ ( I ) ) , \\ {I}_{2} = ℱ ( Gating ( {I}_{1} ) ) , \\ {I}_{out} = {ℱ}^{- 1} ( {W}_{p}^{0} {I}_{2} ) + I , \\ Gating ( I ) = 𝒢 ( {W}_{d}^{1} {W}_{p}^{1} ( ℒ ( I ) ) ) ⊙ {W}_{d}^{2} {W}_{p}^{2} ( ℒ ( I ) ) ,\end{matrix} \qquad ( 8 )$$

where [symbol] and [symbol] represent a Fast Fourier transform and an inverse Fast Fourier transform thereof, respectively, ⊙ represents element-wise multiplication, [symbol] represents a GELU non-linearity,

$${W}_{p}^{1} and {W}_{p}^{2}$$

represent 1×1 point convolutions,

$${W}_{d}^{1} and {W}_{d}^{2}$$

represent 3×3 depthwise convolutions, and [symbol] (⋅) represents layer normalization.

In some embodiments, as shown in FIG. 3, the detailed network architecture of the frequency-domain gating module comprises the following processing flow: input data first undergoes layer normalization (Norm), and an output of the layer normalization subsequently branches into two separate data paths. A first data path is processed sequentially by a pointwise convolution (Conv1×1) and a depthwise convolution (Dconv3×3), followed by GELU activation. The first data path then undergoes a Fast Fourier Transform (FFT) and is multiplied element-wise by a quantization matrix W. A second data path is processed sequentially by a pointwise convolution (Conv1×1) and a depthwise convolution (Dconv3×3). The processed result from the second path is then combined with the processed result from the first path. The combined result subsequently undergoes an Inverse Fast Fourier Transform (IFFT). Finally, an output of the IFFT is added element-wise to the original input data to produce the final output, thereby completing the entire architectural processing flow.

In some embodiments of the present disclosure, the FGFN, as the backbone of the Transformer model, enhances learning and transmission of features by scaling the aggregated feature, thereby facilitating reconstruction of a clear image.

A standard feedforward network uses two 1×1 convolutions, one for expanding feature channels and the other for restoring the feature channels to the original input dimension. Different from a Dynamic Feature Fusion Network (DFFN), the FGFN provided in the embodiments of the present disclosure allows each layer to focus on fine details complementary to other layers while adaptively retaining useful frequency information.

A gating mechanism is incorporated into the feedforward network, which is mathematically represented by the element-wise product of two parallel paths of linear transformation layers, wherein one path is activated by a GELU non-linearity. Furthermore, the FGFN includes a depthwise convolution for encoding information of spatially adjacent pixel positions, which is useful for learning local image structures to enable effective restoration.

FIG. 4 is a schematic diagram illustrating an exemplary implementation architecture of a feature enhancement module according to some embodiments of the present disclosure.

In some embodiments, as shown in FIG. 4, the detailed network architecture of the feature enhancement module comprises the following processing flow: input data first undergoes a convolution operation, then processed sequentially through four residual blocks, and finally outputs a result. The data flows sequentially between the modules, completing the entire architectural processing flow.

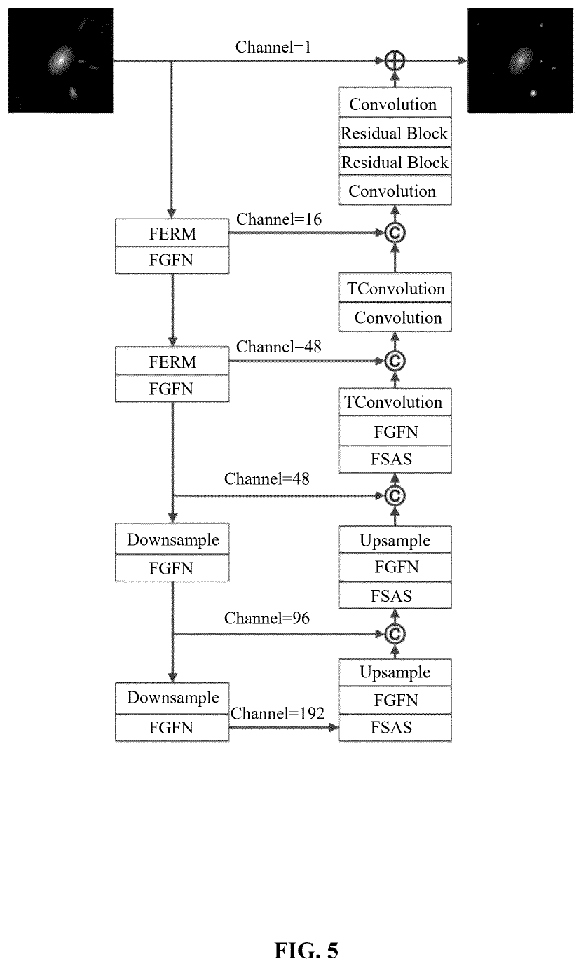

FIG. 5 is an exemplary design diagram illustrating an Iterative Frequency-domain Self-attention Transformer (IFS-Transformer) network model according to some embodiments of the present disclosure.

In some embodiments, as shown in FIG. 5, the main framework of the IFS-Transformer network model adopts an asymmetric encoder-decoder structure.

In some embodiments, the IFS-Transformer network model may apply two FERMs to obtain a low-level feature (denoted as F₀∈R^{H×W×C}) of an input image (denoted as I∈R^{H×W×C}), where H×W represents spatial dimensions, and C represents the count of channels.

In some embodiments, the IFS-Transformer network model may input the low-level feature F₀ into the frequency-domain gating module and performing downsampling to achieve feature encoding, so as to obtain an encoded feature.

In some embodiments, the IFS-Transformer network model may process the encoded feature through three FSASs and two upsampling operations to perform feature learning and decoding, so as to obtain the decoded feature.

In some embodiments, the IFS-Transformer network model may performing frequency-domain attention computation on the encoded feature using three layers of FGFNs, wherein each layer of FGFN is embedded with an FSAS, and performing feature decoding via two upsampling operations to obtain the decoded feature, wherein the decoded feature has the same count of channels as the low-level feature F₀.

In some embodiments, the IFS-Transformer network model may process the decoded feature through two FERMs to obtain the target restored image. The low-level feature F₀ is processed through the asymmetric encoder-decoder structure to obtain a deep feature F₁∈R^{H×W×C}. The encoded feature is concatenated with the decoded feature via a skip connection, and subsequently, a convolution operation is applied to reduce the total count of concatenated channels by half.

In some embodiments, for each of the two FERMs and a decoding module of the FERM, the IFS-Transformer network model may add a residual connection between the FERM and the decoding module of the FERM to generate a residual image I^{res}∈R^{H×W×C} through feature mapping, and fuse the residual image I^{res} with the input image I to obtain the target restored image, represented by Î=I+I^{res}.

In some embodiments of the present disclosure, two FERMs are used to effectively obtain the low-level feature of the input image, retaining rich spatial details and texture information for subsequent processing. In a feature decoding stage, the frequency-domain extraction module combines the frequency-domain attention computation and the upsampling to achieve refined reconstruction of the encoded feature. In particular, a cascaded design of the three layers of FGFNs, combined with the embedded FSAS, significantly improves discriminative capability of a frequency-domain feature. Meanwhile, two upsampling operations ensure channel alignment between the decoded feature and the low-level feature, maintaining feature consistency. In an image reconstruction stage, processing the decoded feature through two FERMs to generate the residual image and then fusing the residual image with the input image not only effectively alleviates a gradient vanishing problem in a deep network but also enhances recovery capability of high-frequency details of the image through feature mapping. The final output target restored image significantly improves performance of tasks such as denoising and super-resolution while maintaining a natural visual effect.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Meanwhile, certain terminology has been used to describe embodiments of the present disclosure. For example, the terms “one embodiment”, “an embodiment”, and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of the present disclosure are not necessarily all referring to the same embodiment. Furthermore, the particular features, structures, or characteristics may be combined as suitable in one or more embodiments of the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

1. A deep-learning-based method for eliminating a broadband effect and a synthesized-beam effect in low-frequency Square Kilometre Array (SKA), comprising:
S1: establishing a Frequency-domain Self-Attention Solver (FSAS), a Feature Extraction Residual Module (FERM), and a Frequency-domain Gated Feedforward Network (FGFN); wherein the FERM consists of a convolutional layer and four residual blocks; and
the FSAS is established by a following equation:
an image patch
$${\{ {q}_{i} \}}_{i = 1}^{n}$$
an image patch
$${\{ {k}_{i} \}}_{i = 1}^{n}$$
and an image patch
$${\{ {v}_{i} \}}_{i = 1}^{n}$$
are extracted from a feature F_{q}, a feature Fₖ, and a feature Fᵥ respectively to obtain a query vector Q, a key vector K, and a value vector V:
$$Q = R ( {\{ {q}_{i} \}}_{i = 1}^{n} ) , K = R ( {\{ {k}_{i} \}}_{i = 1}^{n} ) , V = R ( {\{ {v}_{i} \}}_{i = 1}^{n} ) ;$$
where n represents a count of image patches; R represents a reshape function, which reshapes {K,Q,V} to satisfy {K,Q,V}∈R^{N×(CH}^{ₚ}^{W}^{ₚ}⁾, Hₚ and Wₚ represent a height and a width of the image patches, and C is a count of channels;
scaled dot-product attention is obtained by a following equation:
where each element of QK^{T} is obtained by inner product:
$${( {QK}^{T} )}_{ij} = 〈 {q}_{i} , {k}_{i} 〉 ;$$
where qᵢ and kᵢ represent vectorized forms of the i-th and j-th image patches from F_{q} and Fₖ respectively;
the feature F_{q}, the feature Fₖ, and the feature Fᵥ are obtained by 1×1 convolution and 3×3 convolution respectively; then Fast Fourier Transform is performed on F_{q} and Fₖ, and a correlation between F_{q} and Fₖ, in the frequency domain is estimated by a following equation:
$$A = {ℱ}^{- 1} ( ℱ ( {F}_{q} ) \overline{ℱ ( {F}_{k} )} ) ;$$
where [symbol] and [symbol] represent Fourier transform and its inverse transform respectively, and - represents a conjugate transpose operation;
A is normalized by layer normalization [symbol] (⋅) to estimate an aggregated feature:
$${V}_{att} = ℒ ( A ) {F}_{v} ;$$
finally, an output feature of FSAS is obtained by a following equation:
$${I}_{att} = I + {Conv}_{1 \times 1} ( {V}_{att} ) ;$$
where Conv_{1×1} represents 1×1 convolution; I represents a noisy image (denoted as I∈R^{H×W×C}), with H×W representing spatial dimensions;
the FGFN is established by a following equation:
$$\begin{matrix}{I}_{1} = {Conv}_{1 \times 1} ( ℒ ( I ) ) ; \\ {I}_{2} = ℱ ( Gating ( {I}_{1} ) ) ; \\ {I}_{out} = {ℱ}^{- 1} ( {W}_{p}^{0} {I}_{2} ) + I ; \\ Gating ( I ) = 𝒢 ( {W}_{d}^{1} {W}_{p}^{1} ( ℒ ( I ) ) ) ⊙ {W}_{d}^{2} {W}_{p}^{2} ( ℒ ( I ) ) ;\end{matrix}$$
where [symbol] and [symbol] represent the Fourier transform and its inverse transform respectively; ⊙ represents element-wise multiplication, [symbol] represents a GELU nonlinearity,
$${W}_{p}^{1}$$
represents 1×1 pointwise convolution,
$${W}_{d}^{1}$$
represents 3×3 depthwise convolution, [symbol] (⋅) represents layer normalization;
S2: establishing an IFS-Transformer network model based on the FSAS, FERM and FGFN established in Step S1;
S3: obtaining a low-level feature F₀∈R^{H×W×C} of the noisy image I∈R^{H×W×C} by using two FERMs;
S4: inputting the low-level feature F₀ into the FGFN, and completing an encoding part through two downsampling operations;
S5: performing feature learning and decoding operations on the features obtained from the encoding part through 3 FSASs and two upsampling operations;
S6: obtaining a target restored image after processing by two FERM decoding modules.

2. The deep-learning-based method of claim 1, wherein the neural network model based on the frequency-domain self-attention mechanism includes an Iterative Frequency-domain Self-attention Transformer (IFS-Transformer) network model.

3. The deep-learning-based method of claim 2, wherein the frequency-domain extraction module includes one or more Frequency-domain Self-Attention Solvers (FSASs), the feature enhancement module includes one or more Feature Extraction Residual Modules (FERMs), and the frequency-domain gating module includes one or more Frequency-domain Gated Feedforward Networks (FGFNs).

4. The deep-learning-based method of claim 3, wherein the FERM consists of a convolutional layer and four residual blocks.

5. The deep-learning-based method of claim 4, wherein the frequency-domain extraction module is constructed by performing operations including:
determining, based on input feature data, a query vector, a key vector, and a value vector through image patch extraction and linear transformation;
determining, based on the query vector and the key vector, an aggregated feature through attention weight calculation and weighted aggregation; and
determining, based on the input feature data and the aggregated feature, an output feature of the frequency-domain extraction module through a residual connection.

6. The deep-learning-based method of claim 5, wherein the input feature data includes a feature F_{q}, a feature Fₖ, and a feature Fᵥ; and the determining, based on input feature data, a query vector, a key vector, and a value vector through image patch extraction and linear transformation includes:
obtaining, based on the feature F_{q}, the feature Fₖ, and the feature Fᵥ, an image patch
$${\{ {q}_{i} \}}_{i = 1}^{n} ,$$
an image patch
$${\{ {k}_{i} \}}_{i = 1}^{n} ,$$
and an image patch
$${\{ {v}_{i} \}}_{i = 1}^{n}$$
through the image patch extraction; and
obtaining, based on the image patch
$${\{ {q}_{i} \}}_{i = 1}^{n} ,$$
the image patch
$${\{ {k}_{i} \}}_{i = 1}^{n} ,$$
and the image patch
$${\{ {v}_{i} \}}_{i = 1}^{n} ,$$
a query vector Q, a key vector K, and a value vector V through the linear transformation:
$$Q = R ( {\{ {q}_{i} \}}_{i = 1}^{n} ) , K = R ( {\{ {k}_{i} \}}_{i = 1}^{n} ) , V = R ( {\{ {v}_{i} \}}_{i = 1}^{n} ) ,$$
wherein R represents a reshape function, i represents an i-th image patch, n represents a count of image patches, qᵢ represents a vectorized form of the i-th image patch from the feature F_{q}, kᵢ represents a vectorized form of the i-th image patch from the feature Fₖ, and vᵢ represents a vectorized form of the i-th image patch from the feature Fᵥ.

7. The deep-learning-based method of claim 6, wherein the determining, based on the query vector and the key vector, an aggregated feature through attention weight calculation and weighted aggregation includes:
determining, based on the query vector Q and the key vector K, a similarity between the query vector Q and the key vector K;
determining, based on the similarity between the query vector Q and the key vector K, an attention distribution by performing normalization processing; and
determining, based on the attention distribution and the value vector V, the aggregated feature through the weighted aggregation.

8. The deep-learning-based method of claim 7, wherein the determining, based on the query vector Q and the key vector K, a similarity between the query vector Q and the key vector K includes:
determining the similarity QK^{T} between the query vector Q and the key vector K through a following equation:
$${( Q {K}^{T} )}_{ij} = 〈 {q}_{i} , {k}_{i} 〉$$
wherein each element of QK^{T} is obtained via an inner product.

9. The deep-learning-based method of claim 8, wherein the determining, based on the similarity between the query vector Q and the key vector K, an attention distribution by performing normalization processing includes:
obtaining the attention distribution by normalizing the similarity between the query vector Q and the key vector K using a Softmax function according to a following equation:
$$softmax ( \frac{Q {K}^{T}}{\sqrt{C {H}_{p} {W}_{p}}} ) ,$$
wherein C represents a count of channels, Hₚ represents a height of an extracted image patch, and Wₚ represents a width of the extracted image patch.

10. The deep-learning-based method of claim 9, wherein the determining, based on the attention distribution and the value vector V, the aggregated feature through the weighted aggregation includes:
determining, based on the attention distribution and the value vector V, the aggregated feature through the weighted aggregation using a following equation:
$${V}_{att} = softmax ( \frac{Q {K}^{T}}{\sqrt{C {H}_{p} {W}_{p}}} ) V ,$$
wherein Vₐₜₜ represents the aggregated feature.

11. The deep-learning-based method of claim 4, wherein construction of the frequency-domain extraction module includes:
determining, based on input feature data, a frequency-domain correlation matrix through a frequency-domain transform technique;
determining, based on the frequency-domain correlation matrix, an aggregated feature through a layer normalization technique; and
determining, based on the input feature data and the aggregated feature, an output feature of the frequency-domain extraction module through a residual connection.

12. The deep-learning-based method of claim 11, wherein the input feature data includes a feature F_{q}, a feature Fₖ, and a feature F_{q}; and the determining, based on input feature data, a frequency-domain correlation matrix through a frequency-domain transform technique includes:
estimating the frequency-domain correlation matrix, denoted as A, between the F_{q} and the F_{q} in a frequency domain by performing a Fast Fourier Transform on the feature F_{q}, the feature F_{q}, and the feature F_{q}, using a following equation:
$$A = {ℱ}^{- 1} ( ℱ ( {F}_{q} ) \overline{ℱ ( {F}_{k} )} ) .$$

13. The deep-learning-based method of claim 12, wherein the determining, based on the frequency-domain correlation matrix, an aggregated feature through a layer normalization technique includes:
determining the aggregated feature, denoted as Vₐₜₜ, by normalizing the frequency-domain correlation matrix using a layer norm [symbol] (⋅):
$${V}_{att} = ℒ ( A ) {F}_{v} .$$

14. The deep-learning-based method of claim 3, wherein the construction of the frequency-domain gating module includes:
determining, based on an input tensor, an output tensor through a gated linear transformation, frequency-domain bidirectional processing, and a residual connection.

15. The deep-learning-based method of claim 14, wherein construction of the frequency-domain gating module further includes:
representing the frequency-domain gating module based on the input tensor, denoted as I∈R^{Ĥ×Ŵ×Ĉ}, through following equations:
$${I}_{1} = {Conv}_{1 \times 1} ( ℒ ( I ) ) ,$$
$${I}_{2} = ℱ ( Gating ( {I}_{1} ) ) ,$$
$${I}_{out} = {ℱ}^{- 1} ( {W}_{p}^{0} {I}_{2} ) + I ,$$
$$Gating ( I ) = 𝒢 ( {W}_{d}^{1} {W}_{p}^{1} ( ℒ ( I ) ) ) ⊙ {W}_{d}^{2} {W}_{p}^{2} ( ℒ ( I ) ) .$$

16. The deep-learning-based method of claim 3, wherein the performing primary feature extraction on an input image based on the feature enhancement module to obtain a low-level feature includes:
applying two FERMs to obtain the low-level feature, denoted as F₀∈R^{H×W×C}, of the input image, denoted as I∈R^{H×W×C}.

17. The deep-learning-based method of claim 3, wherein the inputting the encoded feature into the frequency-domain extraction module and performing frequency-domain attention computation and upsampling to achieve feature decoding, so as to obtain a decoded feature includes:
processing the encoded feature through three FSASs and two upsampling operations to perform feature learning and decoding, so as to obtain the decoded feature.

18. The deep-learning-based method of claim 1, wherein in step S3, for the decoder part, three layers of FGFNs are used for processing, each layer of FGFN is embedded with the FSAS, and two upsampling operations are performed to restore the output feature to a same count of channels as that of the low-level feature F₀.

19. The deep-learning-based method of claim 3, wherein the inputting the decoded feature into the feature enhancement module to obtain a target restored image includes:
processing the decoded feature through two FERMs to obtain the target restored image.

20. The deep-learning-based method of claim 1, wherein in step S4, a residual connection is added between the two FERMs and corresponding decoding modules respectively, convolution is performed on the a refined feature to generate a residual image I^{res} ∈R^{H×W×C} which is then added to the noisy image to obtain the target restored image: Î=I+I^{res}.
